(19) United States
(12) Patent Application Publication
(10) Pub. No.: US 2009/0234689 A1
(43) Pub. Date: Sep. 17, 2009

(54) METHOD AND A SYSTEM FOR SUPPORTING ENTERPRISE BUSINESS GOALS

(75) Inventors: Oren Simon, Ramat Gan (IL); Israel Beniaminy, Ramat Gan (IL); Moshe Ben Bassat, Lexington, MA (US)

Correspondence Address: KATTEN MUCHIN ROSENMAN LLP, 575 MADISON AVENUE, NEW YORK, NY, 10022-2585, US

(73) Assignee: CLICKSOFTWARE TECHNOLOGIES LTD., Tel Aviv (IL)

(21) Appl. No.: 12/233,748

(22) Filed: Sep. 19, 2008

Related U.S. Application Data
(63) Continuation-in-part of application No. 12/046,480, filed on Mar. 12, 2008.

(51) Int. Cl. G06Q 10/00

(52) U.S. Cl. 705/7

(57) ABSTRACT

A system and method for model-based translation of a business requirement specification into a business solution specification. The method comes asking minimal questions; creating a fully-working solution; and engaging in dialog to adjust the solution to enterprise needs, such that the business becomes fully operational in the shortest possible time and proceeds to attempt to improve with each successive step.

### FIELD OF THE INVENTION

The present invention generally relates to methods and systems for enterprise management, and more particularly to a method and a system for a new approach to Enterprise Resource Planning (ERP) and enterprise business goals.

### BACKGROUND OF THE INVENTION

For software-as-a-service, Web-based software or on-demand applications, products such as NetSuite™ and Salesforce.com™ are changing how small and mid-sized businesses look at productivity tools. The rise of these Web-based services means enterprise-class business tools without the big hardware costs or long deployment times. However, “Enterprise Software”, and more generally “Business Process Reengineering,” are well-known to suffer from:
Long and costly processes for requirement gathering;
Highly subjective decisions made regarding requirements and appropriate solutions;
High estimates of costs and durations;
Budget and schedule overruns—missing the estimates;
Gaps between reality and the designers' or implementers' understanding;
Over-promising and under-delivery; and
High costs of changing to meet new business situations.
Evidence of these issues can be listed as follows:
   The success rate in customer relationship management (CRM) deployment is low—e.g. 15% “full success” in an IBM study;”
   The same IBM study says “developing a value proposition, managing the budget process, change management, governance, and process change . . . can boost the success rate among CRM projects to 80 percent;” and
   Other areas of enterprise software have similarly low success—see http://www.lessons-from-history.com/Level%202/Project%20Success%20or%20Failure.html. These are generally attributed to misaligned requirements, budget, decisions, planning, and change management.
Prior art measures taken to address these issues include:
   “Change management” and “Business analysis” practices;
   Consulting groups developing expertise and commanding very high prices;
   Modular software architectures, e.g. Service Oriented Architecture (SOA); and
   “Software as a Service” claiming to require zero or minimal configuration effort—but limited in what it can supply.
The present art provides these stages:
   Analyze business needs;
   define requirements;
   design solution;
   implement via assembling, configuring and integrating solution components;
   deploy;
   test;
   fix;
   support; and
   repeat to respond to changes
The State of the Art is still lacking:
   Repeatable, trainable, scalable ways of translating business understanding into operational decisions regarding:
      Choosing and prioritizing goals
      Defining plans to achieve these goals; and
      Implementing plans through training people and through configuring software;
   Minimization of subjectivity in the above translation;
   Performing the above in a “Continuous-improvement” cycle as mandated by business environment, goals etc;
   Process for concretizing lessons learned and delivering them to other groups, lines of businesses, or operations; and
   A solution to the most pressing prior art problem where upon implementing deployment, the business situation has changed so much that the solution is no longer appropriate, and a gap in understanding develops during the analysis and design stages.

### SUMMARY OF THE INVENTION

Accordingly, it is a principal object of the present invention to provide a method for a new approach to Enterprise Resource Planning (ERP) and enterprise business goals.

It is one more principal object of the present invention to provide a method for business planning and implementation where the effort is always one of maintenance mode, never design mode.

It is one further principal object of the present invention to provide a method for business planning and implementation having the following steps:
asking minimal questions;
creating a fully-working solution as soon as possible, simply because “time is money”; and
engaging in dialog to adjust the solution to enterprise needs.

It is another principal object of the present invention to provide a method where the initial deployment is very similar to the change process which already-deployed systems routinely have gone through.

It is one other principal object of the present invention to support multiple roles and perspectives, such that each user interacts with the solution differently, subject to at least two items making up the context of the interaction: role of the user, and stage in the process.

Lee Iacocca, the president of Ford and the CEO of Chrysler Corporation said “So what do we do? Anything. Something. So long as we just don't sit there. If we screw it up, start over. Try something else. If we wait until we've satisfied all the uncertainties, it may be too late.” This is the essence of the present invention:
asking minimal questions;
creating a fully-working solution (as a quick first step); and
engaging in dialog to adjust the solution to enterprise needs.

There has thus been outlined, rather broadly, the more important features of the invention in order that the detailed description thereof that follows hereinafter may be better understood. Additional details and advantages of the invention will be set forth in the detailed description, and in part wilt be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is an exemplary schematic illustration of a shared model empowering a goal-driven enterprise to continuously and harmoniously adapt to a changing WORLD through the collaboration of complementing roles executing consecutive stages, constructed in accordance with an embodiment of the invention;

FIG. 2 is a schematic illustration of a knowledge-based, goal-driven cycle for business planning, implementing, monitoring and managing, constructed in accordance with an embodiment of the invention;

FIG. 3 is a schematic illustration of the two modes of the goal driven enterprise cycle, Preparation in which what-if scenarios are analyzed to define a desired solution and Run in which such solutions are implemented, constructed in accordance with an embodiment of the invention; and

FIG. 4 is a schematic illustration of the architecture for enterprise goal-driven business planning, implementation, monitoring and management, constructed in accordance with an embodiment of the invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

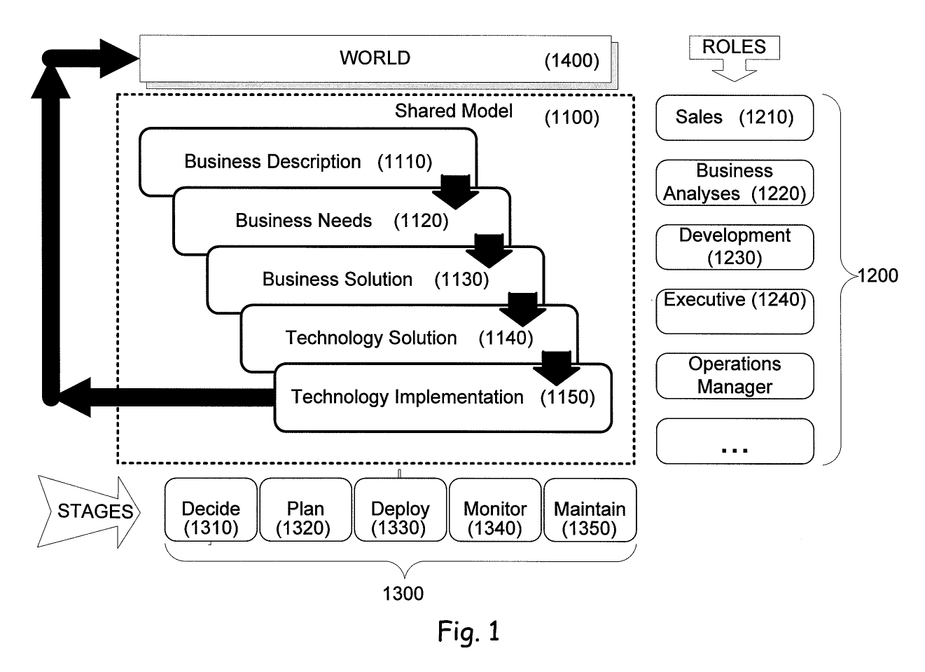

FIG. 1 is an exemplary schematic illustration of a shared model 1100 empowering a goal-driven enterprise to continuously and harmoniously adapt to a changing WORLD (world-at-large) 1400 through the collaboration of complementing roles 1200 executing consecutive stages 1300, constructed in accordance with an embodiment of the invention.

Shared model 1100 is a knowledge base comprised of factual information derived from the world-at-large. Shared model 1100 provides a common interpretation of the world to harmonize the activities of process collaborators in their various roles 1200 and through stages 1300 of the business cycle.

The embedded knowledge in shared model 1100 comprises a description of the business 1110, its needs 1120, a business solution 1130 to satisfy needs 1120, a technology solution 1140 mirroring business solution 1130 and the implementation 1150 of technology solution 1140. Roles 1200 include, for example: sales 1210, business analyses 1220, deployment 1230, executive 1240 and operations manager 1250 define “what the business is” and at what stage 1300 the business is in the process. WORLD 1400 is generally exemplified and manifested by interactions over the World-Wide-Web or Internet.

The Knowledge Base of shared model 1100 supporting the architecture is structured as a catalog of business entities, choices and rules linking relevance and validity of choices to other gathered information. It is equipped with editing tools and learning capabilities, such as aggregation, data-mining and pattern inference, and includes ways to identify when the requirements exceed the “operational envelope” of capabilities supported by current contents.

Additional functions of exemplary knowledge base shared model 1100 are:
supporting tags for contextual exploration, security and ownership of knowledge capsules and aggregates; one type of tagging relates to aspects of the context of the interaction, supporting the above-mentioned capability for the context-dependent flow guided by user role and stage in the process;
supporting distribution for large bodies of knowledge, which may be created by collaborating but separate groups; and
allowing knowledge to be shared between groups, while allowing the owner of each item of knowledge to define whether the item is to be shared, at what costs, with what accompanying data, such as identity of the contributor, reasons and results of adding this knowledge, etc.

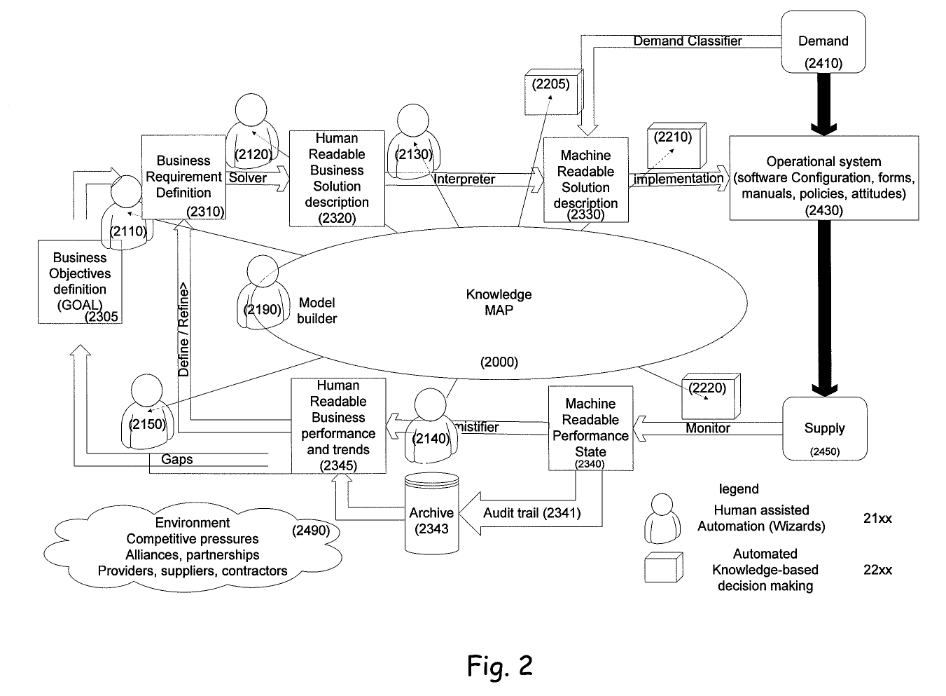

FIG. 2 is a schematic illustration of a knowledge-based, goal-driven cycle for business planning, implementing, monitoring and managing, constructed in accordance with an embodiment of the invention. A central knowledge map 2000 supports human assisted 21xx and automated 22xx evolutionary stages in the business cycle. Starting with a business objectives definition 2305—the enterprise goals, a set of defined business requirements 2310 are established using a model based wizard 2110.

Business level requirements definitions 2310 are then solved by a model based wizard solver 2120 into a business solution 2320 that is maintained in a human readable form. Solution 2320, in its human readable form 2320 is then interpreted by a human model-supported assistance interpreter 2130 into a machine readable solution description 2330. Description 2330, in turn is automatically implemented 2210 into the operational system 2430 in the form of software configuration, manuals, operation scripts and policy statements.

Real world demand 2410 is fed into operational system 2430 to estimate the supply 2450 for it. Demand 2410 is constantly monitored and classified 2205 automatically to improve the correctness of solution 2330 being established for the current conditions. Demand 2410 represents the direct effect of the real world on the business. The metrics of supply 2450 are monitored 2220 and automatically translated into a performance “state” description 2340. Performance is constantly audited and demystified 2140 to create a description of the current state of affairs, the observed human readable business performance measurements and trends 2345. In parallel to demystifier 2140, an audit trail 2341 is collected in an archive 2343 to enable the perception of trends.

Business performance and trends 2340 are both fed back, through a refine/define wizard 2150 into business requirements definition 2310 and analyzed for gaps vis-a-vis changes in the environment (world-at-large) 2490 to re-adjust definitions of business objectives and goals 2305.

Changes in the model used for the various parts of the cycle are a part of the natural evolution of the system. This is preferably reflected in new world phenomena and internal changes in the enterprise. A knowledge model builder 2190 enables analysis and incorporation of such changes and is a key for establishing a learning system that is agile and built to reflect change.

To establish the cycle a system with the following details is described:

Information-gathering “sensors” comprising questionnaires with pre-defined possible answers, automated data gathering and automated configuration-gathering; and

Suggesting/implementing policies and “actuators,” which are mechanisms for creating:
business documents: presentations, business cases, relevant case studies, return-on-on-investment (ROI), recommended policies, change management;
technical documents: designs, architecture, integration, configuration, work plans; and
changes to software components: settings, parameters and configuration, policy documentation, process documentation and manuals.

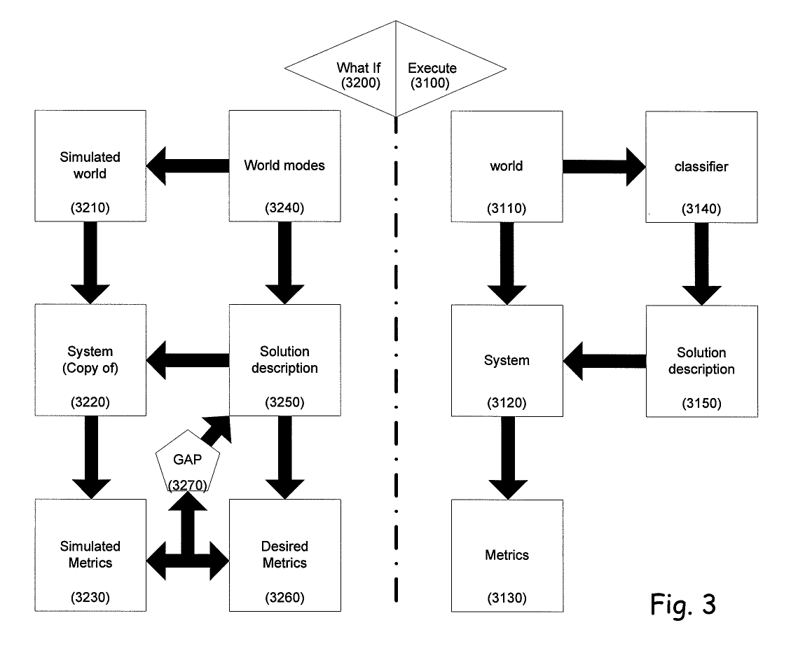

FIG. 3 is a schematic illustration of the two modes of the goal driven enterprise cycle, What If mode 3200 and Execute mode 3100, constructed in accordance with an embodiment of the invention. The method of the present invention starts with a reasonable guess of a solution and adapts it to requirements as they develop using a trial and error approach in the form of a “What If” simulation that is run on a copy of the same system that is currently in operational mode. In What If mode 3200 potential scenarios are analyzed to define desired solutions. In Execute mode 3100 such solutions are implemented. In Execute mode 3100 the World 3110 is “fed” into the system 3120, resulting in captured metrics 3130. In What If mode 3200 a simulated world 3210 is “fed” into a copy of the system 3220 to yield simulated metrics 3230.

In Execute mode 3100 World 3110 is also classified 3140 so that the best solution 3150 can be implemented as system 3120. In What If mode 3200 the roles are reversed, with the World modes 3240 defining both simulated world 3210 and a corresponding solution 3250. Solution 3250 is implemented as system copy 3220 and defines what metrics are desired 3260. Comparing desired metrics 3260 with simulated metrics 3230 a gap 3270 can be established and used to refine solution 3250.

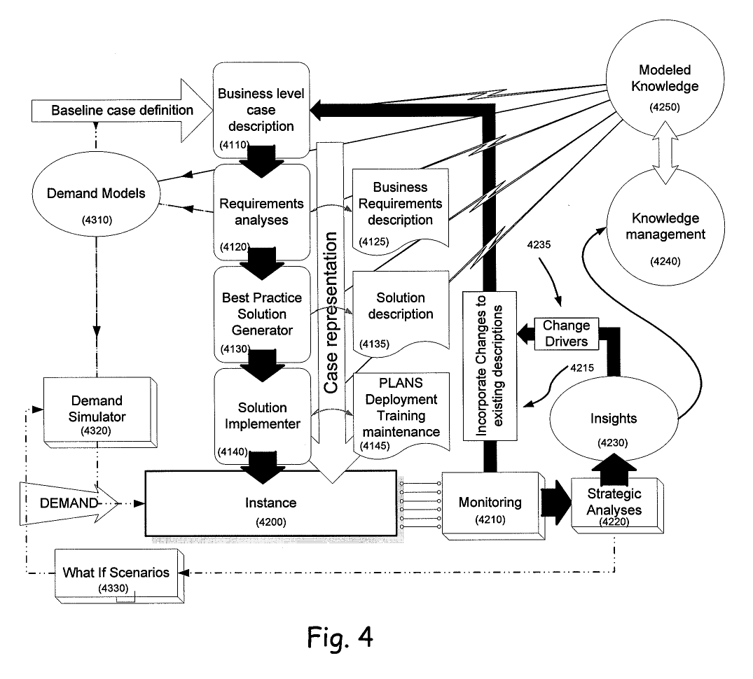

FIG. 4 is a schematic illustration of the architecture for enterprise goal-driven business planning, implementation, monitoring and management, constructed in accordance with an embodiment of the invention.

Starting with a business case definition (preliminary) a business level case description 4110 is established. A requirements analysis 4120 is then performed, and documented as a business requirements description 2125. Once the requirements are captured, a best solution generator 2130 is engaged resulting in a solution description 4135 document. This solution is then implemented 2140 and documented 2145 to create an operational instance 4200.

With actual demand “fed” into the instance 4200, it is monitored 4210, and gaps in expected performance affect changes 4215 in the initial description 4110. Monitoring results is also made available to a strategic analyzer 4220, which provide new insights 4230, and is used to drive changes in requirements 4235 and through the knowledge management console 4240 is embedded in the modeled knowledge 4250 used to drive the transformation of a case definition 4110 through the various stages to become an operational instance 4200.

The baseline case definition, the modeled knowledge 4250 and the current set of requirements 4120 are used to create a demand model 4310 used in a what-if mode. These demand models 4310 are used by a demand simulator 4320 to generate simulated demand to the operating instances 4200 for what-if analyses. Monitoring 4210 is provided for analyses 4220 and influence the What-if scenarios 4330 used for the generation of simulated demand.

In this way the real world system and the what-if simulated system are converged to constantly generate hypothesis and test it, evaluate the result and embedding said results in the real operating system.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for model-based translation of a business requirement specification into a business solution specification comprising, the method comprising:
asking minimal questions;
creating a fully-working solution; and
engaging in dialog to adjust the solution to enterprise needs,
such that the business becomes fully operational in the shortest possible time and proceeds to attempt to improve with each successive step.

2. A method for a Human-Machine hybrid perpetual adaptive process of business and operations alignment comprising of world modeling, world sensing, business modeling and business sensing, coupled with automated, and human supervised/guided translation processes reacting to changes in the world and to arbitrary sets of goals and objectives defined for the business.

3. The method of claim 1, further comprising automated (as per model) translating, disambiguating and learning through model driven fact-finding human interaction processes.

4. A method for model-based translation of a Human readable business solution specification into a machine readable Solution specification comprising of automated (as per model) translations and disambiguation and learning through a model driven fact-finding human interaction processes.

5. A method for Knowledge-based implementation of a business solution specification into the operating environment itself (code, configuration, policy statement, manuals, scripts, procedures, actions . . . ) comprising of automated operation layer actuators.

6. A cyclic method for closing a gap in understanding in the business process that develops during the analysis and design stages, the method comprising:
producing a Machine-readable Configuration Description (MCD);
sending “Actuators” by MCD to a module responsible for Software, Configuration, Procedures and Policies;
receives a Snap Shot by MCD from said module responsible for Software in return;
reading MCD by a human reader;
passing MCD through a filtering Wizard to produce a Human-readable Configuration Description (HCD);
passing HCD through an Interpreter in conjunction with a Knowledge Map and BusReqs Wizard to produce a set of as-built Business Objectives; and
collapsing said as-built Business Objectives into an “import” state to complete the cycle of redefining Business Requirements in order to close the gap in understanding with each iteration of the cycle.

7. A system for model-based translation of a business requirement specification into a business solution specification comprising, the system comprising:
means for asking minimal questions;
means for creating a fully-working solution; and
means for engaging in dialog to adjust the solution to enterprise needs,
such that the business becomes fully operational in the shortest possible time and proceeds to attempt to improve with each successive step.
